(19) United States
(12) Patent Application Publication
(10) Pub. No.: US 2012/0166975 A1
(43) Pub. Date: Jun. 28, 2012

(54) MOBILE TERMINAL AND CONTROLLING METHOD THEREOF

(76) Inventors: Sesook OH, Chungnam (KR); Namki KIM, Seoul (KR); Soohyun KIM, Seoul (KR); Seungmyoung LEE, Seoul (KR)

(21) Appl. No.: 13/220,727

(22) Filed: Aug. 30, 2011

(30) Foreign Application Priority Data
Dec. 23, 2010 (KR) 10-2010-0133302

(51) Int. Cl. G06F 3/01

(52) U.S. Cl. 715/760

(57) ABSTRACT

A mobile terminal and controlling method thereof are disclosed, which facilitates a terminal to be used in further consideration of user's convenience. The present invention includes simultaneously executing a first web browser and a second web browse, displaying the executed first web browser on the touchscreen, if a first touch action is performed on the touchscreen while the first web browser displays a first current webpage, controlling the first web browser to display a first previous webpage or a first next webpage, and if a second touch action is performed on the touchscreen while the first web browser displays the first current webpage, controlling the first web browser to disappear and controlling the second web browser to appear. Accordingly, the present invention facilitates a switching to a different webpage from the displayed webpage in further consideration of user's convenience despite a user input unit of a limited type and a display screen of a limited size in the mobile terminal.

Pursuant to 35 U.S.C. §119(a), this application claims the benefit of earlier filing date and right of priority to Korean Application No. 10-2010-0133302, filed on Dec. 23, 2010, the contents of which are hereby incorporated by reference herein in their entirety.

### BACKGROUND OF THE INVENTION

1. Field of the Invention

The present invention relates to a mobile terminal, and more particularly, to a mobile terminal and controlling method thereof. Although the present invention is suitable for a wide scope of applications, it is particularly suitable for facilitating a terminal to be used in further consideration of user's convenience.

2. Discussion of the Related Art

A mobile terminal is a device which may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Generally, terminals can be classified into mobile terminals and stationary terminals according to a presence or non-presence of mobility. And, the mobile terminals can be further classified into handheld terminals and vehicle mount terminals according to availability for hand-carry.

There are ongoing efforts to support and increase the functionality of mobile terminals. Such efforts include software and hardware improvements, as well as changes and improvements in the structural components which form the mobile terminal.

The mobile terminal is able to access Internet and then display a webpage. The demand for enabling a convenient switching to a different webpage from the displayed webpage despite a user input unit of a limited type and a display screen of a limited size in the mobile terminal is rising in further consideration of user's convenience.

### SUMMARY OF THE INVENTION

Accordingly, the present invention is directed to a mobile terminal and controlling method thereof that substantially obviate one or more problems due to limitations and disadvantages of the related art.

An object of the present invention is to provide a mobile terminal and controlling method thereof, by which a switching to a different webpage from the displayed webpage is facilitated in further consideration of user's convenience despite a user input unit of a limited type and a display screen of a limited size in the mobile terminal.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a mobile terminal according to the present invention includes a touchscreen, a wireless communication unit for internet access, and a controller configured to simultaneously execute a first web browser and a second web browser, display the executed first web browser on the touchscreen, if a first touch action is performed on the touchscreen while the first web browser displays a first current webpage, control the first web browser to display a first previous webpage or a first next webpage, and if a second touch action is performed on the touchscreen while the first web browser displays the first current webpage, control the first web browser to disappear and control the second web browser to appear.

In another aspect of the present invention, a method of controlling a mobile terminal according to the present invention includes simultaneously executing a first web browser and a second web browser, displaying the executed first web browser on the touchscreen, if a first touch action is performed on the touchscreen while the first web browser displays a first current webpage, controlling the first web browser to display a first previous webpage or a first next webpage, and if a second touch action is performed on the touchscreen while the first web browser displays the first current webpage, controlling the first web browser to disappear and controlling the second web browser to appear.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. The above and other aspects, features, and advantages of the present invention will become more apparent upon consideration of the following description of preferred embodiments, taken in conjunction with the accompanying drawing figures. In the drawings:

FIG. 1 is a block diagram of a mobile terminal according to one embodiment of the present invention;

FIG. 2A is a front perspective diagram of a mobile terminal according to one embodiment of the present invention;

FIG. 2B is a rear perspective diagram of a mobile terminal according to one embodiment of the present invention;

FIG. 3 is a diagram for one example of a web browser executable to access an internet and a webpage displayable on the executed web browser in a mobile terminal according to an embodiment of the present invention;

FIG. 4 is a flowchart for a method of controlling a mobile terminal according to an embodiment of the present invention;

FIG. 5 and FIG. 6 are diagrams of display screen configurations for implementing a method of controlling a mobile terminal according to an embodiment of the present invention;

FIG. 7 is a diagram of display screen configurations for implementing a method of controlling a mobile terminal according to an embodiment of the present invention;

FIG. 8 is a diagram of display screen configurations for implementing a method of controlling a mobile terminal according to an embodiment of the present invention;

FIG. 9 is a diagram of display screen configurations for implementing a method of controlling a mobile terminal according to an embodiment of the present invention;

FIG. 10 is a flowchart for a method of controlling a mobile terminal according to an embodiment of the present invention;

FIGS. 11 to 13 are diagrams of display screen configurations for implementing a method of controlling a mobile terminal according to an embodiment of the present invention;

FIG. 14 is a flowchart for a method of controlling a mobile terminal according to an embodiment of the present invention; and

FIG. 15 and FIG. 16 are diagrams of display screen configurations for implementing a method of controlling a mobile terminal according to an embodiment of the present invention.

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

As used herein, the suffixes ‘module’, ‘unit’ and ‘part’ are used for elements in order to facilitate the disclosure only. Therefore, significant meanings or roles are not given to the suffixes themselves and it is understood that the ‘module’, ‘unit’ and ‘part’ can be used together or interchangeably.

The present invention can be applicable to a various types of terminals. Examples of such terminals include mobile terminals, such as mobile phones, user equipment, smart phones, mobile computers, digital broadcast terminals, personal digital assistants, portable multimedia players (PMP) and navigators.

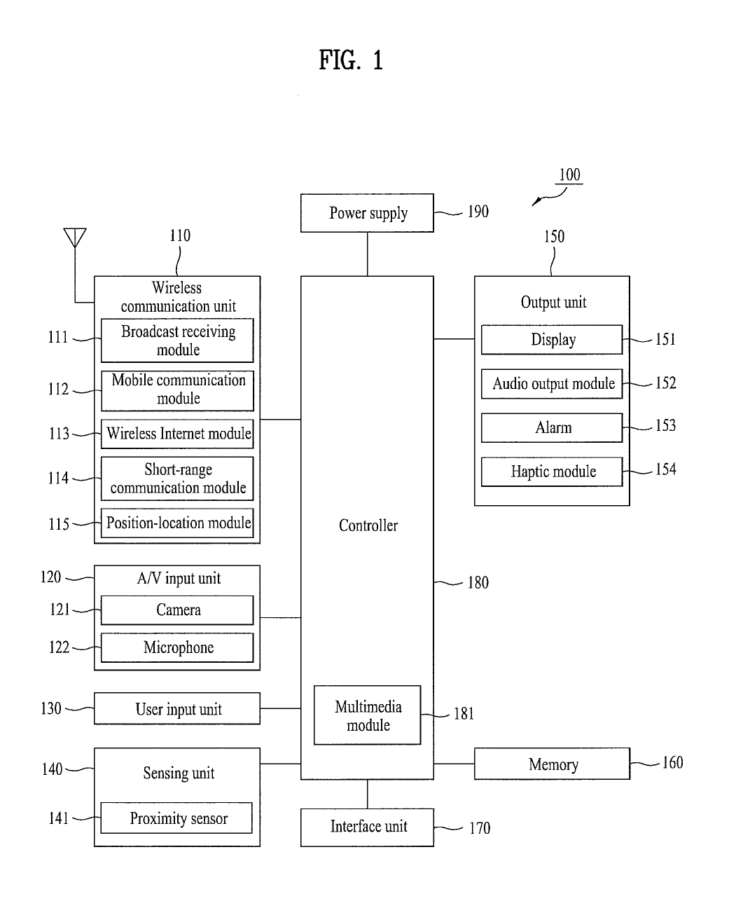

FIG. 1 is a block diagram of a mobile terminal 100 in accordance with an embodiment of the present invention. FIG. 1 shows the mobile terminal 100 according to one embodiment of the present invention includes a wireless communication unit 110, an A/V (audio/video) input unit 120, a user input unit 130, a sensing unit 140, an output unit 150, a memory 160, an interface unit 170, a controller 180, a power supply unit 190 and the like. FIG. 1 shows the mobile terminal 100 having various components, but it is understood that implementing all of the illustrated components is not a requirement. Greater or fewer components may alternatively be implemented.

In the following description, the above elements of the mobile terminal 100 are explained in sequence.

First of all, the wireless communication unit 110 typically includes one or more components which permits wireless communication between the mobile terminal 100 and a wireless communication system or network within which the mobile terminal 100 is located. For instance, the wireless communication unit 110 can include a broadcast receiving module 111, a mobile communication module 112, a wireless internet module 113, a short-range communication module 114, a position-location module 115 and the like.

The broadcast receiving module 111 receives a broadcast signal and/or broadcast associated information from an external broadcast managing server via a broadcast channel.

The broadcast channel may include a satellite channel and a terrestrial channel.

The broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and a data broadcast signal, among others. If desired, the broadcast signal may further include a broadcast signal combined with a TV or radio broadcast signal.

At least two broadcast receiving modules 111 can be provided to the mobile terminal 100 in pursuit of simultaneous receptions of at least two broadcast channels or broadcast channel switching facilitation.

The broadcast associated information includes information associated with a broadcast channel, a broadcast program, a broadcast service provider, etc. And, the broadcast associated information can be provided via a mobile communication network. In this case, the broadcast associated information can be received by the mobile communication module 112.

The broadcast associated information can be implemented in various forms. For instance, broadcast associated information may include an electronic program guide (EPG) of digital multimedia broadcasting (DMB) and electronic service guide (ESG) of digital video broadcast-handheld (DVB-H).

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), DVB-CBMS, OMA-BCAST, the data broadcasting system known as media forward link only (MediaFLO®) and integrated services digital broadcast-terrestrial (ISDB-T). Optionally, the broadcast receiving module 111 can be configured suitable for other broadcasting systems as well as the above-explained digital broadcasting systems.

The broadcast signal and/or broadcast associated information received by the broadcast receiving module 111 may be stored in a suitable device, such as a memory 160.

The mobile communication module 112 transmits/receives wireless signals to/from one or more network entities (e.g., base station, external terminal, server, etc.) via a mobile network such as GSM (Global System for Mobile communications), CDMA (Code Division Multiple Access), WCDMA (Wideband CDMA) and so on. Such wireless signals may represent audio, video, and data according to text/multimedia message transceivings, among others.

The wireless internet module 113 supports Internet access for the mobile terminal 100. This module may be internally or externally coupled to the mobile terminal 100. In this case, the wireless Internet technology can include WLAN (Wireless LAN) (Wi-Fi), Wibro (Wireless broadband), Wimax (World Interoperability for Microwave Access), HSDPA (High Speed Downlink Packet Access), GSM, CDMA, WCDMA, LTE (Long Term Evolution), etc.

Wireless internet access by Wibro, HSPDA, GSM, CDMA, WCDMA, LTE or the like is achieved via a mobile communication network. In this aspect, the wireless internet module 113 configured to perform the wireless internet access via the mobile communication network can be understood as a sort of the mobile communication module 112.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

The position-location module 115 identifies or otherwise obtains the location of the mobile terminal 100. If desired, this module may be implemented with a global positioning system (GPS) module.

According to the current technology, the GPS module 115 is able to precisely calculate current 3-dimensional position information based on at least one of longitude, latitude and altitude and direction (or orientation) by calculating distance information and precise time information from at least three satellites and then applying triangulation to the calculated information. Currently, location and time informations are calculated using three satellites, and errors of the calculated location position and time informations are then amended using another satellite. Besides, the GPS module 115 is able to calculate speed information by continuously calculating a real-time current location.

Referring to FIG. 1, the audio/video (A/V) input unit 120 is configured to provide audio or video signal input to the mobile terminal 100. As shown, the A/V input unit 120 includes a camera 121 and a microphone 122. The camera 121 receives and processes image frames of still pictures or video, which are obtained by an image sensor in a video call mode or a photographing mode. And, the processed image frames can be displayed on the display 151.

The image frames processed by the camera 121 can be stored in the memory 160 or can be externally transmitted via the wireless communication unit 110. Optionally, at least two cameras 121 can be provided to the mobile terminal 100 according to environment of usage.

The microphone 122 receives an external audio signal while the portable device is in a particular mode, such as phone call mode, recording mode and voice recognition. This audio signal is processed and converted into electric audio data. The processed audio data is transformed into a format transmittable to a mobile communication base station via the mobile communication module 112 in case of a call mode. The microphone 122 typically includes assorted noise removing algorithms to remove noise generated in the course of receiving the external audio signal.

The user input unit 130 generates input data responsive to user manipulation of an associated input device or devices. Examples of such devices include a keypad, a dome switch, a touchpad (e.g., static pressure/capacitance), a jog wheel, a jog switch, etc.

The sensing unit 140 provides sensing signals for controlling operations of the mobile terminal 100 using status measurements of various aspects of the mobile terminal. For instance, the sensing unit 140 may detect an open/close status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100. As an example, consider the mobile terminal 100 being configured as a slide-type mobile terminal. In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device. And, the sensing unit 140 can include a proximity sensor 141.

The output unit 150 generates outputs relevant to the senses of sight, hearing, touch and the like. And, the output unit 150 includes the display 151, an audio output module 152, an alarm unit 153, and a haptic module 154 and the like.

The display 151 is typically implemented to visually display (output) information associated with the mobile terminal 100. For instance, if the mobile terminal is operating in a phone call mode, the display will generally provide a user interface (UI) or graphical user interface (GUI) which includes information associated with placing, conducting, and terminating a phone call. As another example, if the mobile terminal 100 is in a video call mode or a photographing mode, the display 151 may additionally or alternatively display images which are associated with these modes, the UI or the GUI.

The display module 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can be implemented in a transparent or optical transmittive type, which can be named a transparent display. As a representative example for the transparent display, there is TOLED (transparent OLED) or the like. A rear configuration of the display 151 can be implemented in the optical transmittive type as well. In this configuration, a user is able to see an object in rear of a terminal body via the area occupied by the display 151 of the terminal body.

At least two displays 151 can be provided to the mobile terminal 100 in accordance with the implemented configuration of the mobile terminal 100. For instance, a plurality of displays can be arranged on a single face of the mobile terminal 100 in a manner of being spaced apart from each other or being built in one body. Alternatively, a plurality of displays can be arranged on different faces of the mobile terminal 100.

In case that the display 151 and a sensor for detecting a touch action (hereinafter called ‘touch sensor’) configures a mutual layer structure (hereinafter called ‘touchscreen’), it is able to use the display 151 as an input device as well as an output device. In this case, the touch sensor can be configured as a touch film, a touch sheet, a touchpad or the like.

The touch sensor can be configured to convert a pressure applied to a specific portion of the display 151 or a variation of a capacitance generated from a specific portion of the display 151 to an electric input signal. Moreover, it is able to configure the touch sensor to detect a pressure of a touch as well as a touched position or size.

If a touch input is made to the touch sensor, signal(s) corresponding to the touch is transferred to a touch controller. The touch controller processes the signal(s) and then transfers the processed signal(s) to the controller 180. Therefore, the controller 180 is able to know whether a prescribed portion of the display 151 is touched.

Referring to FIG. 1, a proximity sensor (141) can be provided to an internal area of the mobile terminal 100 enclosed by the touchscreen or around the touchscreen. The proximity sensor is the sensor that detects a presence or non-presence of an object approaching a prescribed detecting surface or an object existing around the proximity sensor using an electromagnetic field strength or infrared ray without mechanical contact. Hence, the proximity sensor has durability longer than that of a contact type sensor and also has utility wider than that of the contact type sensor.

The proximity sensor can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that the touchscreen includes the electrostatic capacity proximity sensor, it is configured to detect the proximity of a pointer using a variation of electric field according to the proximity of the pointer. In this case, the touchscreen (touch sensor) can be classified as the proximity sensor.

The proximity sensor detects a proximity touch and a proximity touch pattern (e.g., a proximity touch distance, a proximity touch duration, a proximity touch position, a proximity touch shift state, etc.). And, information corresponding to the detected proximity touch action and the detected proximity touch pattern can be outputted to the touchscreen.

The audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 is often implemented using one or more speakers, buzzers, other audio producing devices, and combinations thereof.

The alarm unit 153 is output a signal for announcing the occurrence of a particular event associated with the mobile terminal 100. Typical events include a call received event, a message received event and a touch input received event. The alarm unit 153 is able to output a signal for announcing the event occurrence by way of vibration as well as video or audio signal. The video or audio signal can be outputted via the display 151 or the audio output unit 152. Hence, the display 151 or the audio output module 152 can be regarded as a part of the alarm unit 153.

The haptic module 154 generates various tactile effects that can be sensed by a user. Vibration is a representative one of the tactile effects generated by the haptic module 154. Strength and pattern of the vibration generated by the haptic module 154 are controllable. For instance, different vibrations can be outputted in a manner of being synthesized together or can be outputted in sequence.

The haptic module 154 is able to generate various tactile effects as well as the vibration. For instance, the haptic module 154 generates the effect attributed to the arrangement of pins vertically moving against a contact skin surface, the effect attributed to the injection/suction power of air though an injection/suction hole, the effect attributed to the skim over a skin surface, the effect attributed to the contact with electrode, the effect attributed to the electrostatic force, the effect attributed to the representation of hold/cold sense using an endothermic or exothermic device and the like.

The haptic module 154 can be implemented to enable a user to sense the tactile effect through a muscle sense of finger, arm or the like as well as to transfer the tactile effect through a direct contact. Optionally, at least two haptic modules 154 can be provided to the mobile terminal 100 in accordance with the corresponding configuration type of the mobile terminal 100.

The memory unit 160 is generally used to store various types of data to support the processing, control, and storage requirements of the mobile terminal 100. Examples of such data include program instructions for applications operating on the mobile terminal 100, contact data, phonebook data, messages, audio, still pictures (or photo), moving pictures, etc. And, a recent use history or a cumulative use frequency of each data (e.g., use frequency for each phonebook, each message or each multimedia) can be stored in the memory unit 160. Moreover, data for various patterns of vibration and/or sound outputted in case of a touch input to the touchscreen can be stored in the memory unit 160.

The memory 160 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. And, the mobile terminal 100 is able to operate in association with a web storage for performing a storage function of the memory 160 on Internet.

The interface unit 170 is often implemented to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may be configured using a wired/wireless headset port, an external charger port, a wired/wireless data port, a memory card port, a port for coupling to a device having an identity module, audio input/output ports, video input/output ports, an earphone port and/or the like.

The identity module is the chip for storing various kinds of information for authenticating a use authority of the mobile terminal 100 and can include User Identify Module (UIM), Subscriber Identify Module (SIM), Universal Subscriber Identity Module (USIM) and/or the like. A device having the identity module (hereinafter called ‘identity device’) can be manufactured as a smart card. Therefore, the identity device is connectible to the mobile terminal 100 via the corresponding port.

When the mobile terminal 110 is connected to an external cradle, the interface unit 170 becomes a passage for supplying the mobile terminal 100 with a power from the cradle or a passage for delivering various command signals inputted from the cradle by a user to the mobile terminal 100. Each of the various command signals inputted from the cradle or the power can operate as a signal enabling the mobile terminal 100 to recognize that it is correctly loaded in the cradle.

The controller 180 typically controls the overall operations of the mobile terminal 100. For example, the controller 180 performs the control and processing associated with voice calls, data communications, video calls, etc. The controller 180 may include a multimedia module 181 that provides multimedia playback. The multimedia module 181 may be configured as part of the controller 180, or implemented as a separate component.

Moreover, the controller 180 is able to perform a pattern (or image) recognizing process for recognizing a writing input and a picture drawing input carried out on the touchscreen as characters or images, respectively.

The power supply unit 190 provides power required by the various components for the mobile terminal 100. The power may be internal power, external power, or combinations thereof.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

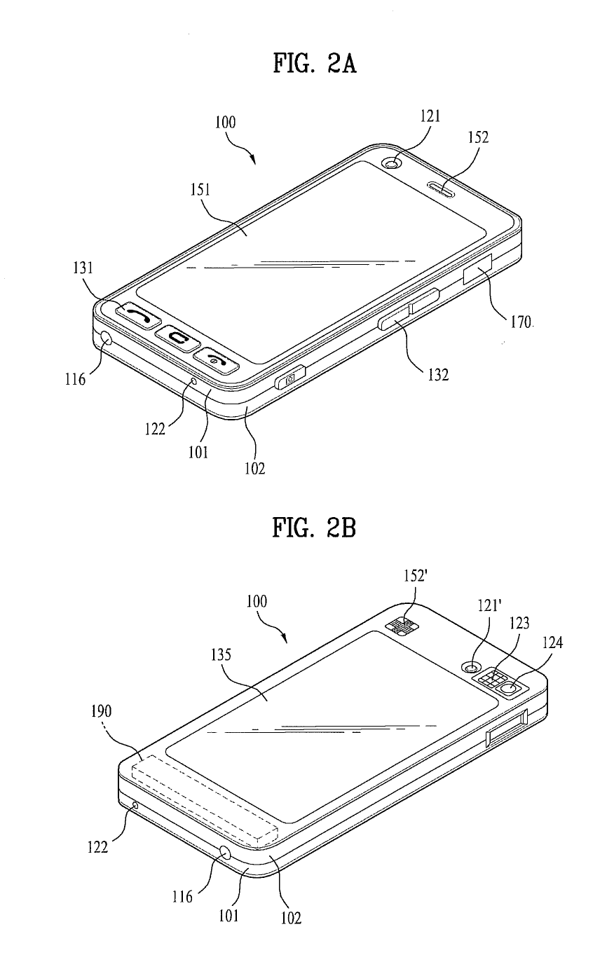

FIG. 2A is a front perspective diagram of a mobile terminal according to one embodiment of the present invention.

The mobile terminal 100 shown in the drawing has a bar type terminal body. Yet, the mobile terminal 100 may be implemented in a variety of different configurations. Examples of such configurations include folder-type, slide-type, rotational-type, swing-type and combinations thereof. For clarity, further disclosure will primarily relate to a bar-type mobile terminal 100. However such teachings apply equally to other types of mobile terminals.

Referring to FIG. 2A, the mobile terminal 100 includes a case (casing, housing, cover, etc.) configuring an exterior thereof. In the present embodiment, the case can be divided into a front case 101 and a rear case 102. Various electric/electronic parts are loaded in a space provided between the front and rear cases 101 and 102. Optionally, at least one middle case can be further provided between the front and rear cases 101 and 102 in addition.

The cases 101 and 102 are formed by injection molding of synthetic resin or can be formed of metal substance such as stainless steel (STS), titanium (Ti) or the like for example.

A display 151, an audio output unit 152, a camera 121, user input units 130/131 and 132, a microphone 122, an interface 180 and the like can be provided to the terminal body, and more particularly, to the front case 101.

The display 151 occupies most of a main face of the front case 101. The audio output unit 151 and the camera 121 are provided to an area adjacent to one of both end portions of the display 151, while the user input unit 131 and the microphone 122 are provided to another area adjacent to the other end portion of the display 151. The user input unit 132 and the interface 170 can be provided to lateral sides of the front and rear cases 101 and 102.

The input unit 130 is manipulated to receive a command for controlling an operation of the terminal 100. And, the input unit 130 is able to include a plurality of manipulating units 131 and 132. The manipulating units 131 and 132 can be named a manipulating portion and may adopt any mechanism of a tactile manner that enables a user to perform a manipulation action by experiencing a tactile feeling.

Content inputted by the first or second manipulating unit 131 or 132 can be diversely set. For instance, such a command as start, end, scroll and the like is inputted to the first manipulating unit 131. And, a command for a volume adjustment of sound outputted from the audio output unit 152, a command for a switching to a touch recognizing mode of the display 151 or the like can be inputted to the second manipulating unit 132.

FIG. 2B is a perspective diagram of a backside of the terminal shown in FIG. 2A.

Referring to FIG. 2B, a camera 121′ can be additionally provided to a backside of the terminal body, and more particularly, to the rear case 102. The camera 121 has a photographing direction that is substantially opposite to that of the former camera 121 shown in FIG. 21A and may have pixels differing from those of the firmer camera 121.

Preferably, for instance, the former camera 121 has low pixels enough to capture and transmit a picture of user's face for a video call, while the latter camera 121′ has high pixels for capturing a general subject for photography without transmitting the captured subject. And, each of the cameras 121 and 121′ can be installed at the terminal body to be rotated or popped up.

A flash 123 and a mirror 124 are additionally provided adjacent to the camera 121′. The flash 123 projects light toward a subject in case of photographing the subject using the camera 121′. In case that a user attempts to take a picture of the user (self-photography) using the camera 121′, the mirror 124 enables the user to view user's face reflected by the mirror 124.

An additional audio output unit 152′ can be provided to the backside of the terminal body. The additional audio output unit 152′ is able to implement a stereo function together with the former audio output unit 152 shown in FIG. 2A and may be used for implementation of a speakerphone mode in talking over the terminal.

A broadcast signal receiving antenna 124 can be additionally provided to the lateral side of the terminal body as well as an antenna for communication or the like. The antenna 124 constructing a portion of the broadcast receiving module 111 shown in FIG. 1 can be retractably provided to the terminal body.

A power supply unit 190 for supplying a power to the terminal 100 is provided to the terminal body. And, the power supply unit 190 can be configured to be built within the terminal body. Alternatively, the power supply unit 190 can be configured to be detachably connected to the terminal body.

A touchpad 135 for detecting a touch can be additionally provided to the rear case 102. The touchpad 135 can be configured in a light transmittive type like the display 151. In this case, if the display 151 is configured to output visual information from its both faces, it is able to recognize the visual information via the touchpad 135 as well. The information outputted from both of the faces can be entirely controlled by the touchpad 135. Alternatively, a display is further provided to the touchpad 135 so that a touchscreen can be provided to the rear case 102 as well.

The touchpad 135 is activated by interconnecting with the display 151 of the front case 101. The touchpad 135 can be provided in rear of the display 151 in parallel. The touchpad 135 can have a size equal to or smaller than that of the display 151.

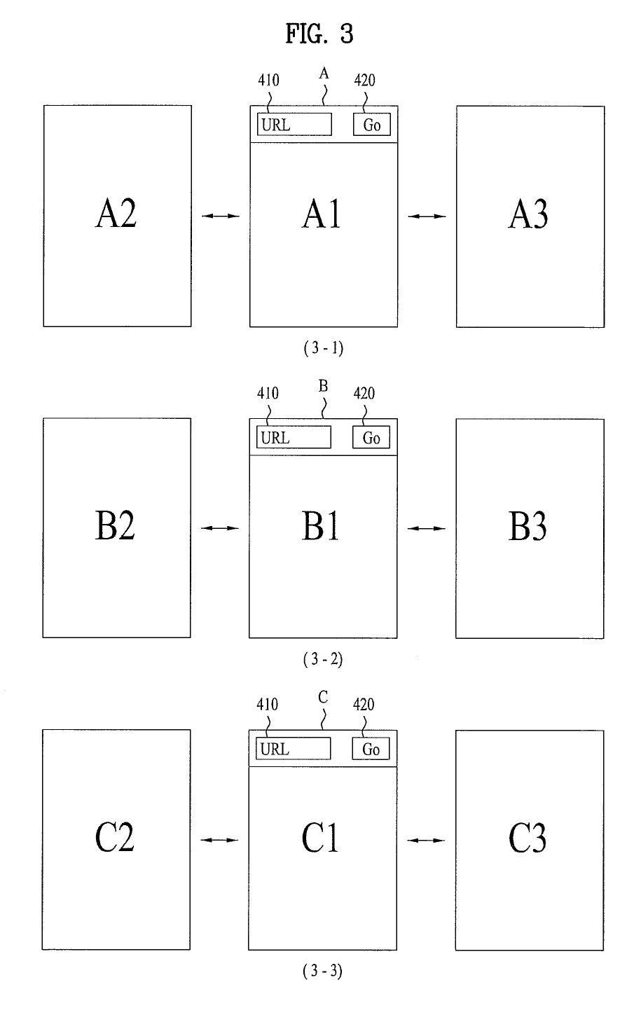

In the following description, a web browser executable to access an internet and a webpage displayable on the executed web browser in a mobile terminal according to an embodiment of the present invention are exemplarily explained with reference to FIG. 3.

FIG. 3 is a diagram for one example of a web browser executable to access an internet and a webpage displayable on the executed web browser in a mobile terminal according to an embodiment of the present invention.

Referring to FIG. 3, the controller 180 is able to control at least two or more web browsers to be simultaneously executed in the mobile terminal 100. In this case, the web browser can be understood as a prescribed application window (or a prescribed application screen) for displaying an internet accessed webpage in the mobile terminal 100. That is, the controller 180 is able to control the at least two prescribed application windows to be executed in the mobile terminal 100. The controller 180 controls the executed at least two prescribed application windows to be displayed simultaneously or one by one.

That the at least two web browsers are simultaneously executed may mean that the at least two web browsers are executable by multitasking. Yet, it is not mandatory for the at least two web browsers to be executed or activated at the same timing point.

In FIG. 3 (3-1) to FIG. 3 (3-3), three web browsers (i.e., web browser A, web browser B and web browser C) executable in the mobile terminal 100 are exemplarily shown. In the present specification, assume that the web browsers are sequentially executed in the mobile terminal 100 in order of ‘the web browser A→the web browser B→the web browser C’.

On each of the web browsers, a URL text input box 410 for inputting a URL of a desired webpage and a URL go icon 420 can be displayed. In this case, the webpage can be understood as a web content provided by a web server of the corresponding URL.

In accordance with a user command given by a terminal user, the controller 180 is able to control a webpage displayed on each of the web browsers A, B and C to be switched to a different webpage. If a link object in the displayed webpage is selected, the displayed webpage can be switched to a different webpage corresponding to the selected link object. Alternatively, if a user directly inputs a desired URL (uniform resource locator) to each of web browsers, the displayed webpage can be switched to a different webpage.

The controller 180 is able to control the memory unit 160 to store a display order of the webpages previously displayed on each of the web browsers.

Using the stored display order, the controller 180 is able to control the web browser to display the previously displayed webpages sequentially.

Referring to FIG. 3 (3-1), the web browser A is displaying a webpage A1. According to the display order stored in association with the web browser A, a previous order of the webpage A1 corresponds to a webpage A2. And, a next order of the webpage A1 corresponds to a webpage A3.

Referring to FIG. 3 (3-2), the web browser B is displaying a webpage B1. According to the display order stored in association with the web browser B, a previous order of the webpage B1 corresponds to a webpage B2. And, a next order of the webpage B1 corresponds to a webpage B3.

Referring to FIG. 3 (3-3), the web browser C is displaying a webpage C1. According to the display order stored in association with the web browser C, a previous order of the webpage C1 corresponds to a webpage C2. And, a next order of the webpage C1 corresponds to a webpage C3.

For clarity and convenience of the following description, assume that each of the webpages A1, B1 and C1 shall be named ‘current webpage’, assume that each of the webpages A2, B2 and C2 shall be named ‘previous webpage’, and assume that each of the webpages A3, B3 and C3 shall be named ‘next webpage’.

In the following description, embodiments related to a controlling method, which can be implemented in the mobile terminal 100, are explained with reference to the accompanying drawings.

If the display module 151 includes a touchscreen, implementation of the following embodiment is further facilitated. Therefore, the following description is made on the assumption that the display module 151 includes a touchscreen. And, a display screen of the touchscreen 151 is indicated by a reference number 400 in the following description.

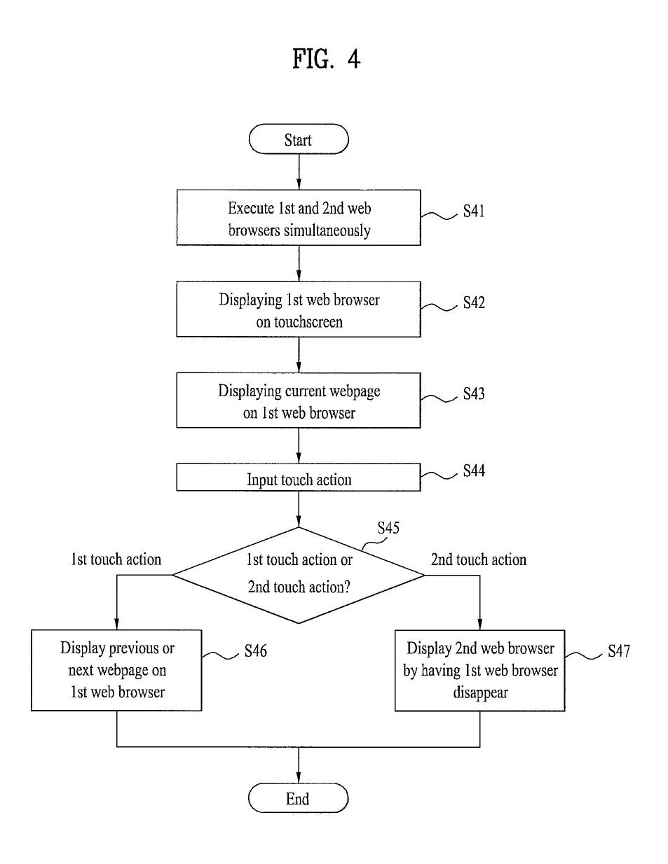

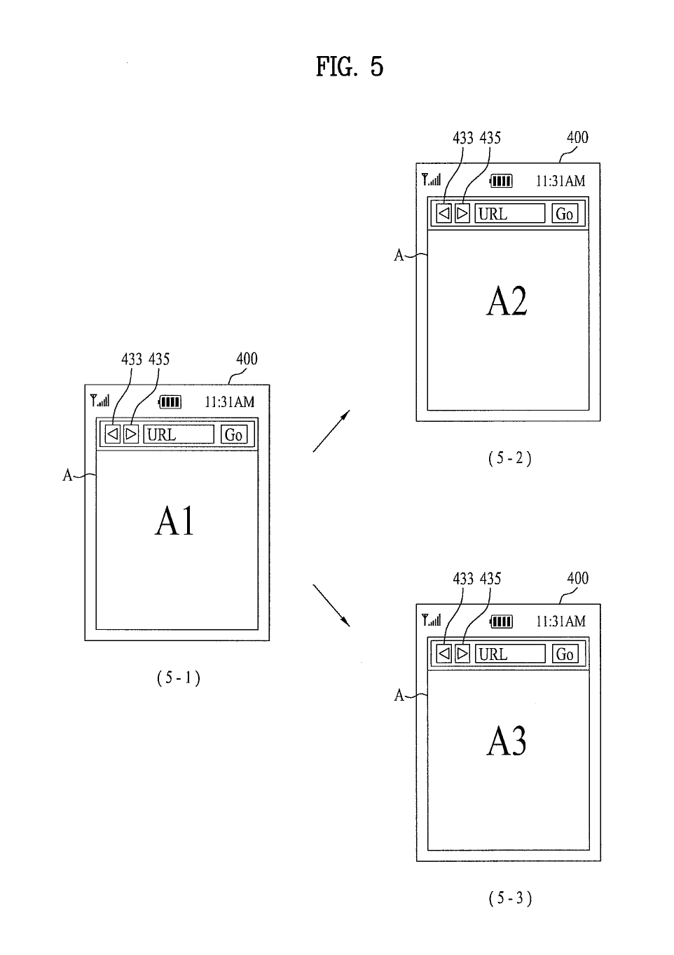

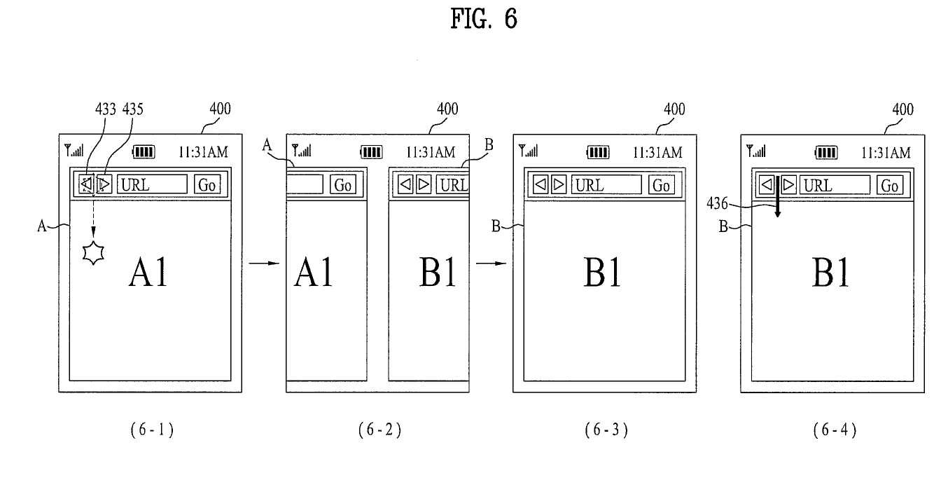

FIG. 4 is a flowchart for a method of controlling a mobile terminal according to an embodiment of the present invention. FIG. 5 and FIG. 6 are diagrams of display screen configurations for implementing a method of controlling a mobile terminal according to an embodiment of the present invention.

Referring to FIGS. 4 to 6, as mentioned in the foregoing description, at least two web browsers can be simultaneously executed in the mobile terminal [S41]. For example, according to the present embodiment, three web browsers (i.e., a first web browser A, a second web browser B and a third web browser C) are simultaneously executable. Since it is apparent to those skilled in the art, to which the present invention pertains, that the first to third web browsers A, B and C can be executed in the mobile terminal 100 through appropriate manipulations, the corresponding details shall be omitted for clarity and convenience of the following description.

As mentioned in the foregoing description, the first to third web browsers A, B and C can display current webpages A1, B1 and C1, respectively.

Referring to FIG. 5 (5-1), assume that the first web browser A among a plurality of the web browsers simultaneously executed in the mobile terminal 100 is currently displayed on the touchscreen 400 [S42].

As mentioned in the foregoing description, the first web browser A1 displayed on the touchscreen 400 can display a first current webpage A1 [S43].

The controller 180 is able to control an icon ‘previous’ 433 and an icon ‘next’ 435 to be provided to the first web browser A. The icon ‘previous’ 433 can be highlighted if a previous webpage exists in the first web browser. And, the icon ‘next’ 435 can be highlighted if a next webpage exists in the first web browser.

The icon ‘previous’ 433 or the icon ‘next’ 435 can be touched with such a pointer as a stylus pen, a finger and the like [S44].

In this case, the touch to the icon can be understood as a sort of a touch action. In the present specification, the touch action conceptionally includes one of a simple touch, a long touch, a double touch, a touch & drag, a touch flicking and the like.

In response to the touch to the icon ‘previous’ 433, referring to FIG. 5 (5-2), the controller 180 is able to control the first current webpage A1 to be switched to the first previous webpage A2 in the first web browser A displayed on the touchscreen 400 [S45, S46]. That is, the first previous webpage A2 appears on the first web browser A, while the first current webpage A1 disappears from the first web browser A.

Alternatively, in response to the touch to the icon ‘next’ 435, referring to FIG. 5 (5-3), the controller 180 is able to control the first current webpage A1 to be switched to the first next webpage A3 in the first web browser A displayed on the touchscreen 400 [S45, S47]. That is, the first next webpage A3 appears on the first web browser A, while the first current webpage A1 disappears from the first web browser A.

Thus, if the icon ‘previous’ 433 or the icon ‘next’ 435 is touched, it can be understood as a sort of a webpage switch command is inputted.

Meanwhile, while the first web browser A displayed on the touchscreen 400 displays the first current webpage A1, referring to FIG. 6 (6-1), at least one of the icon ‘previous’ 433 and the icon ‘next’ 435 is touched with a pointer and can be then dragged in a preset direction [S44]. FIG. 6 (6-1) shows that the preset direction is a bottom direction, by which the present embodiment is non-limited.

In response o the touch & drag, referring to FIG. 6 (6-2) and FIG. 6 (6-3), the controller 180 controls the first web browser A to disappear from the touchscreen 400 and also controls the second web browser B to appear on the touchscreen 400 [S45, S47]. That is, if at least one of the icon ‘previous’ 433 and the icon ‘next’ 435 is touched with the pointer and then dragged in the preset direction, it can be understood as a sort of a web browser switch command is inputted.

The second current webpage B1 may be displayed on the second web browser B newly displayed on the touchscreen 400. In this case, the second web browser B can be provided with the icon ‘previous’ 433 and the icon ‘next’ 435 described in the foregoing description.

When the icon ‘previous’ 433 or the icon ‘next’ 435 of the second web browser B is touched, the controller 180 is able to control the second webpage B1, which is in the second web browser B displayed on the touchscreen 400, to be switched to the second previous webpage B2 or the second next webpage B3 [not shown in the drawing].

Besides, when at least one of the icon ‘previous’ 433 and the icon ‘next’ 435 of the second web browser B is touched with a pointer and then dragged in the preset direction, the controller 180 is able to control the third web browser C to appear on the touchscreen 400 while the second web browser B disappears from the touchscreen 400 [not shown in the drawing]. That is, each time at least one of the icon ‘previous’ 433 and the icon ‘next’ 435 is touched with the pointer and then dragged in the preset direction, the web browsers can be sequentially displayed in their executed sequence (or the sequence reverse to the executed sequence). Moreover, when the touch & drag is performed in the preset direction, the web browsers are displayed in their executed sequence [not shown in the drawing]. When the touch & drag is performed in a direction opposite to the preset direction, the web browsers can be sequentially displayed in a sequence reverse to the executed sequence [not shown in the drawing].

Meanwhile, referring to FIG. 6 (6-4), a touch & drag indicator 436 for guiding at least one of a position and direction of the touch & drag for the web browser switch command can be displayed between the icons 433 and 435. While the first web browser is executed only, the touch & drag indicator 436 may not be displayed. When at least one web browser (e.g., the second web browser and/or the third web browser) is further executed together with the first web browser, the touch & drag indicator 436 can begin to be displayed.

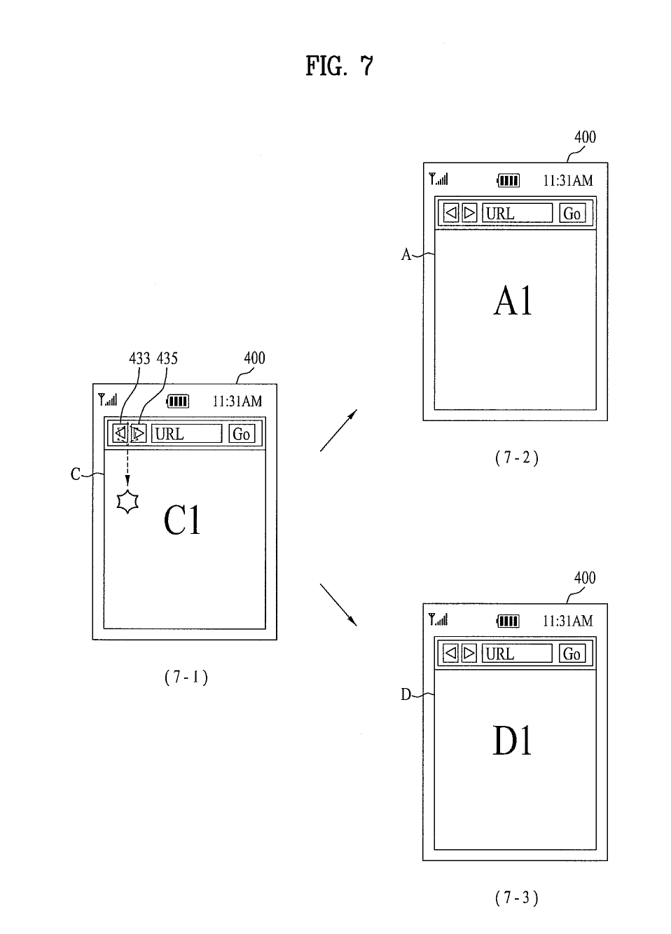

In the following description, a process for inputting the web browser switch command while the third web browser C executed last among the executed web browsers is displayed on the touchscreen 400 is explained in detail with reference to FIG. 7.

FIG. 7 is a diagram of display screen configurations for implementing a method of controlling a mobile terminal according to an embodiment of the present invention.

Referring to FIG. 7 (7-1), while the third web browser C executed last among the executed web browsers is displayed on the touchscreen 400, the web browser switch command can be inputted.

In response to the inputted web browser switch command, referring to FIG. 7 (7-2), the controller 180 is able to control the first web browser A, which is the earliest one executed among the executed web browsers, to be displayed on the touchscreen 400. In particular, each time the web browser switch command is inputted, the web browser switching can be performed in order of ‘first web browser A→second web browser B→third web browser C→first web browser A→second web browser B . . . ’.

Alternatively, in response to the inputted web browser switch command, referring to FIG. 7 (7-3), the controller 180 controls a fourth web browser D to be newly generated in addition to the executed web browsers and then controls the generated fourth web browser D to be displayed on the touchscreen 400. In this case, a fourth current webpage D1 previously set to a homepage can be displayed on the newly generated fourth web browser D.

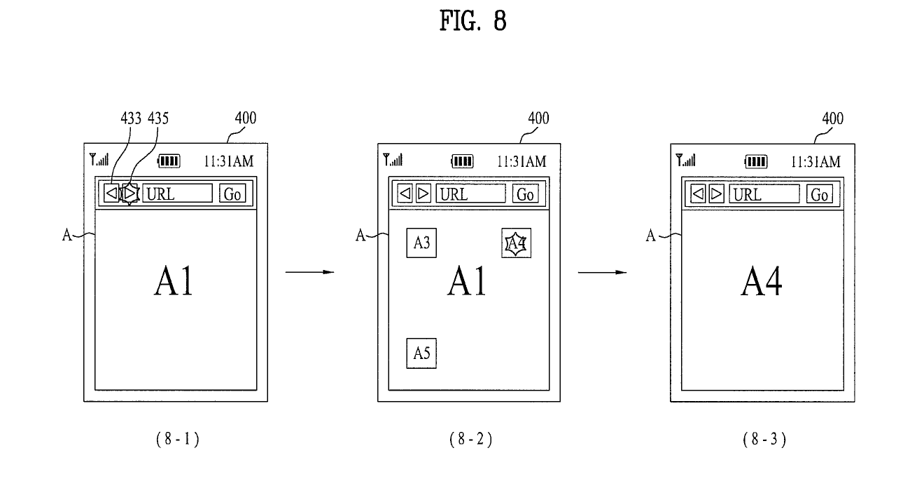

The following description is made with reference to FIG. 8.

FIG. 8 is a diagram of display screen configurations for implementing a method of controlling a mobile terminal according to an embodiment of the present invention. In FIG. 8, according to a display order stored in association with the web browser A, assume that a webpage A3, a webpage A4 and a webpage A5 are sequentially provided (or accessed) next to the webpage A1.

Referring to FIG. 8 (8-1), while the first web browser A displayed on the touchscreen 400 is displaying the first current webpage A1, the icon ‘next’ 435 can be touched.

In response to the touch to the icon ‘next’ 435, referring to FIG. 8 (8-2), the controller 180 controls a list of webpages A3, A4 and A5 next to the first current webpage A1 to be displayed on the first web browser A. The next webpages A3, A4 and A5 can be displayed as thumbnails in a manner of being overlaid on the first current webpage A1 of the first web browser A.

Thereafter, the webpage A4 can be touched and selected from the displayed list of the next webpages.

If so, referring to FIG. 8 (8-3), the controller 180 controls the first current webpage A1 to disappear from the first web browser A and also controls the selected webpage A4 to be displayed instead.

When the icon ‘previous’ 433 is touched and selected from the first web browser A, a list of the previous webpages of the first current webpage A1 can be displayed on the first web browser A [not shown in the drawing]. When a desired webpage is selected from the list, as mentioned in the foregoing description, the selected webpage can be displayed on the first [not shown in the drawing] A.

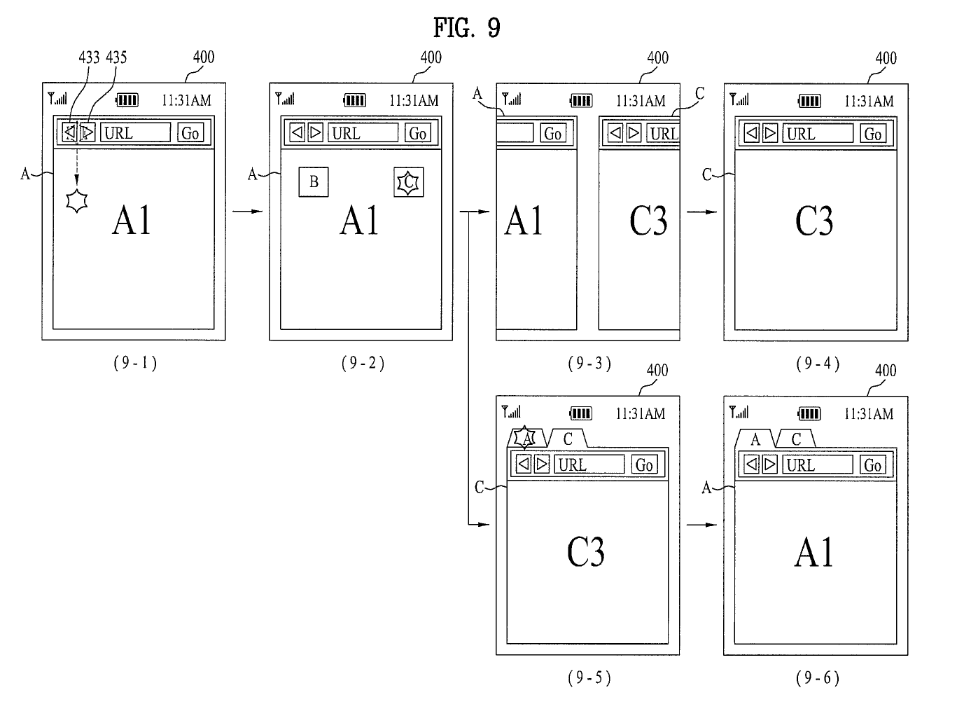

The following description is made with reference to FIG. 9.

FIG. 9 is a diagram of display screen configurations for implementing a method of controlling a mobile terminal according to an embodiment of the present invention.

Referring to FIG. 9 (9-1), while the first web browser A displayed on the touchscreen 400 displays the first current webpage A1, the web browser switch command can be inputted.

In response to the web browser switch command, referring to FIG. 9 (9-2), the controller 180 controls a list the web browsers B and C currently executed in the mobile terminal 100 to be displayed on the first web browser A. In particular, the currently executed web browsers B and C can be displayed as thumbnails in a manner of being overlaid on the first current webpage A1 of the first web browser A.

The third web browser C can be touched and selected from the displayed list of the currently executed web browsers.

If so, referring to FIG. 9 (9-3) and FIG. 9 (9-4), the controller 180 controls the first web browser A to disappear from the touchscreen 400 and also controls the selected third web browser C to be displayed instead. In particular, the first web browser A and the third web browser C are partially displayed temporarily and simultaneously and the third web browser C is then displayed as a whole. In doing so, a webpage displayed on the third web browser C can include a webpage C3 that is last accessed by a user.

Meanwhile, as the third web browser C in the list of the web browsers is touched, if a switching between the first web browser A and the third web browser C is performed, referring to FIG. 9 (9-5), the controller 180 controls the first and third web browsers to be tabbed in a way that the third web browser C is overlaid on the first web browser A.

If a tab of the tabbed first web browser A is touched, referring to FIG. 9 (9-6), the controller 180 is able to control the first web browser A to be displayed again.

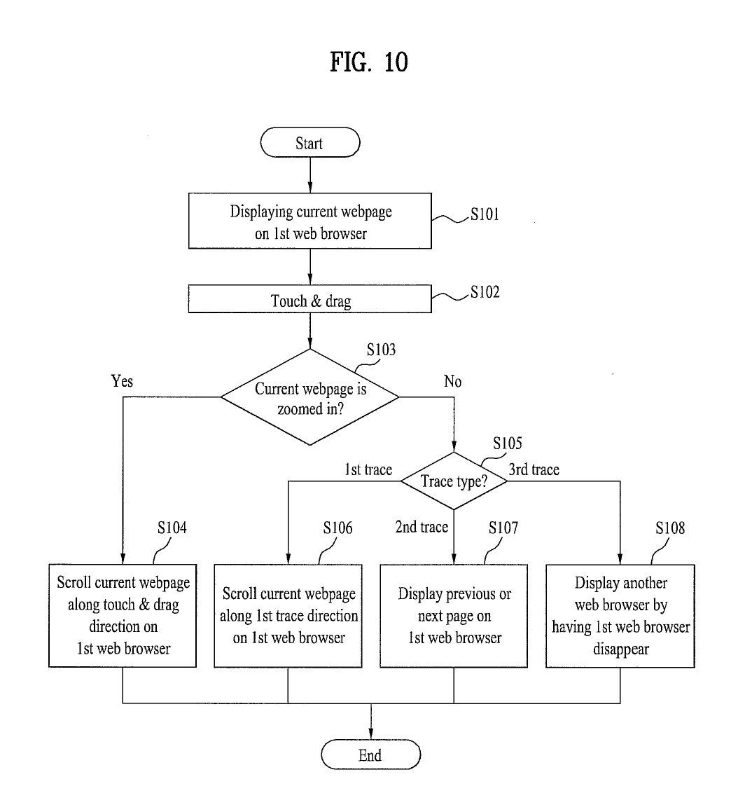

According to the above description, in order to input the webpage switch command or the web browser switch command, the icon ‘previous’ and the icon ‘next’ are displayed on the web browser displayed on the touchscreen. Yet, it is not mandatory for the icon ‘previous’ and the icon ‘next’ to be displayed on the touchscreen 400. This is described in detail with reference to FIGS. 10 to 13 as follows.

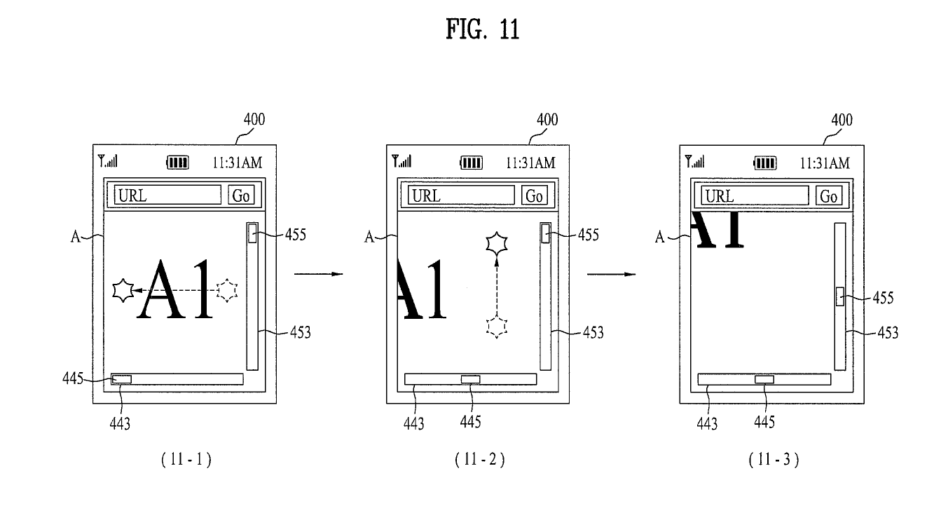

FIG. 10 is a flowchart for a method of controlling a mobile terminal according to an embodiment of the present invention. FIGS. 11 to 13 are diagrams of display screen configurations for implementing a method of controlling a mobile terminal according to an embodiment of the present invention.

Referring to FIG. 11 (11-1), a first web browser A for zooming in to display a first current webpage A1 can be displayed on the touchscreen 400 [S101]. In FIG. 11 (11-1), exemplarily shown is that a horizontal scroll bar 443 and a vertical scroll bar 453 are displayed on the touchscreen 400 to indicate that the first current webpage A1 is zoomed in. In particular, a horizontal scroll indicator 445 and a vertical scroll indicator 455 can be displayed within the horizontal scroll bar 443 and the vertical scroll bar 453 to indicate a zoom-in position of the displayed webpage, respectively.

Thereafter, a touch & drag can be inputted to the touchscreen 400 [S102].

If the touch & drag is inputted, the controller 180 determines whether the first current webpage A1 within the first web browser A is displayed by being zoomed in [S103].

As a result of the determination, if the first current webpage A1 is displayed by being zoomed in, referring to FIG. 11 (11-2) and FIG. 11 (11-3), the controller 180 is able to control the first current webpage A1 within the first web browser A to be scrolled along the direction of the touch & drag [S104].

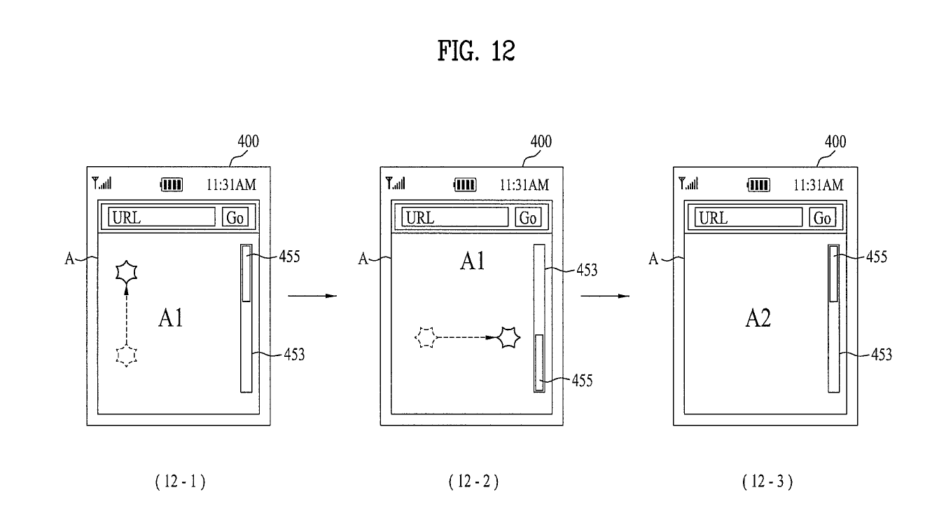

Referring to FIG. 12 (12-1), a first web browser A, which displays a first current webpage A1 in a manner of zooming out the first current webpage A1 completely, can be displayed on the touchscreen 400 [S101]. In FIG. 12 (12-1), as the first current webpage A1 is completely zoomed out, the horizontal scroll bar 443 disappears from the touchscreen 400 but the vertical scroll bar 453 is displayed on the touchscreen 400 only. Besides, as the first current webpage A1 is completely zoomed out, both of the horizontal scroll bar 443 and the vertical scroll bar 453 can disappear from the touchscreen 400.

Thereafter, a touch & drag can be inputted to the touchscreen 400 [S102].

If the touch & drag is inputted, the controller 180 determines whether the first current webpage A1 is displayed within the first web browser A by being zoomed in [S103].

As a result of the determination, if the first current webpage A1 is displayed not by being zoomed in but by being completely zoomed out, the controller 180 determines a trace of the touch & drag again [S105].

As a result of the determination [S105], if the trace of the touch & drag is a vertical straight line, referring to FIG. 12 (12-2), the controller 180 is able to control the first current web browser A1 to be scrolled along a direction (i.e., a vertical direction) of the trace of the touch & drag [S106].

As a result of the determination [S105], if the trace of the touch & drag is a horizontal straight line, referring to FIG. 12 (12-3), the controller 180 is able to recognize the touch & drag of the horizontal straight line trace as the webpage switch command [S107]. For instance, the touch & drag of the horizontal straight line trace in a left direction corresponds to a selection of the icon ‘next’. And, the touch & drag of the horizontal straight line trace in a right direction can correspond to a selection of the icon ‘previous’.

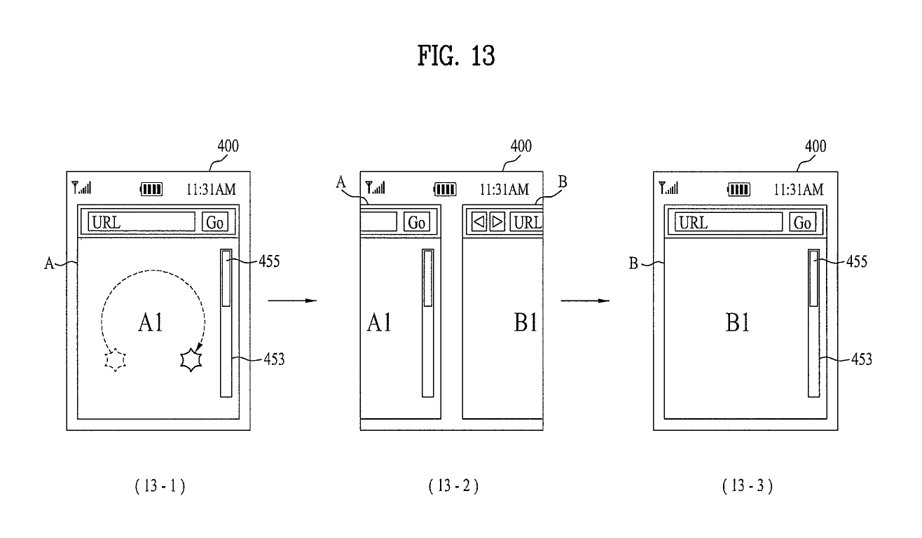

Meanwhile, if the touch & drag has a trace (e.g., a circular trace) different from a straight line, referring to FIG. 13 (13-1) to FIG. 13 (13-3), the controller 180 is able to recognize the touch & drag having the trace different from the straight line as the web browser switch command [S108]. For instance, if the touch & drag has a clockwise circular trace, the web browser is switched in an execution order of the web browser. For another instance, if the touch & drag has a counterclockwise circular trace, the web browser can be switched in order reverse to the execution order of the web browser.

When the webpage switch command or the web browser switch command is inputted by the touch & drag, it is apparent to those skilled in the art that the aforesaid webpage list or the aforesaid web browser list can be displayed [not shown in the drawing].

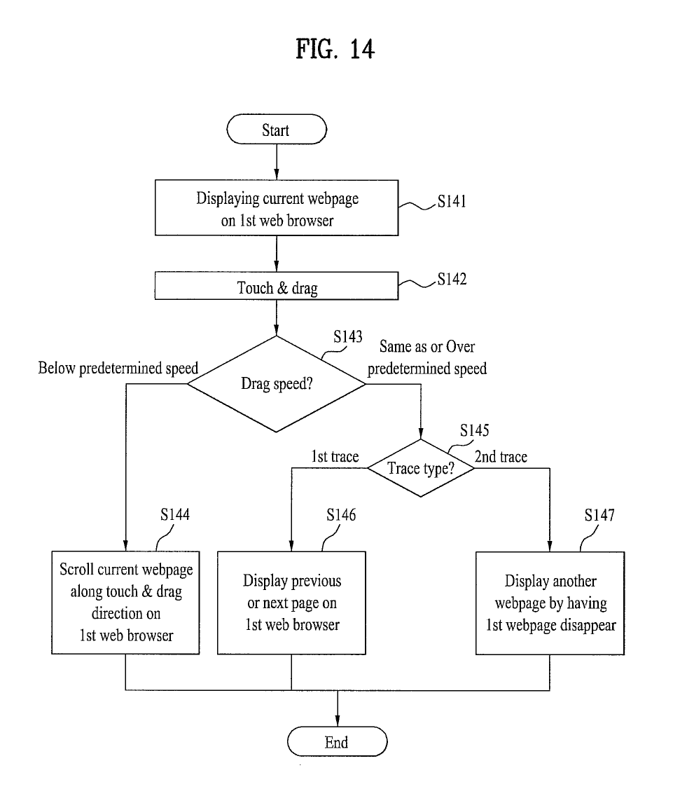

According to the above description, when the touch & drag is performed on the touchscreen, the touch & drag is differently recognized as a command in accordance with whether a webpage displayed on the touchscreen is zoomed in, by which the present embodiment is non-limited. For instance, when a touch & drag is performed on the touchscreen, the corresponding touch & drag can be differently recognized in accordance with a speed of the touch & drag. This is described in detail with reference to FIGS. 14 to 16 as follows.

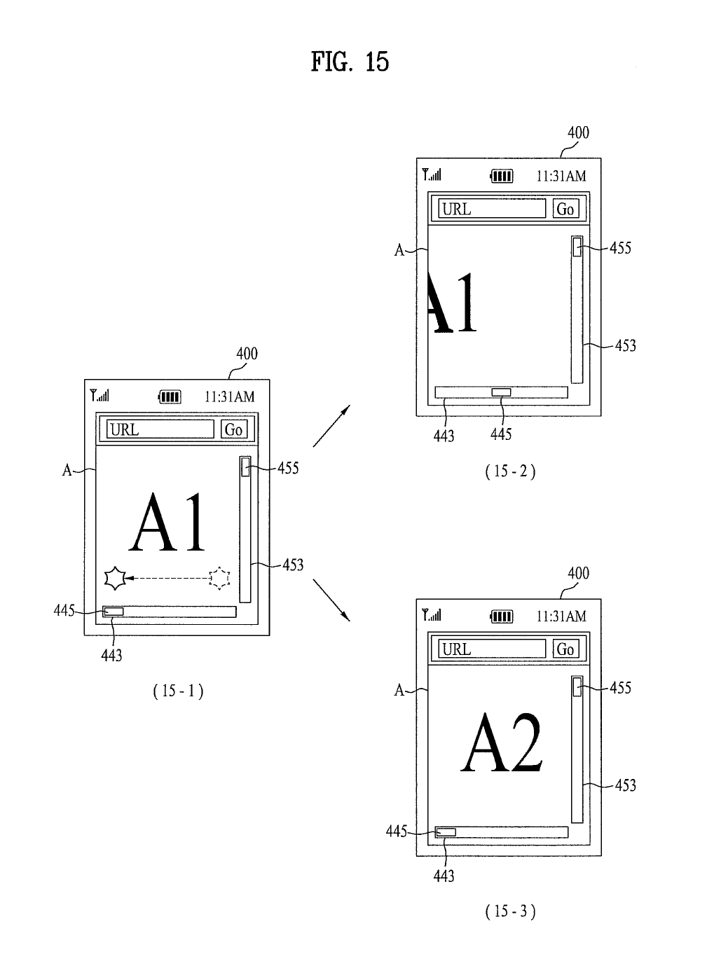

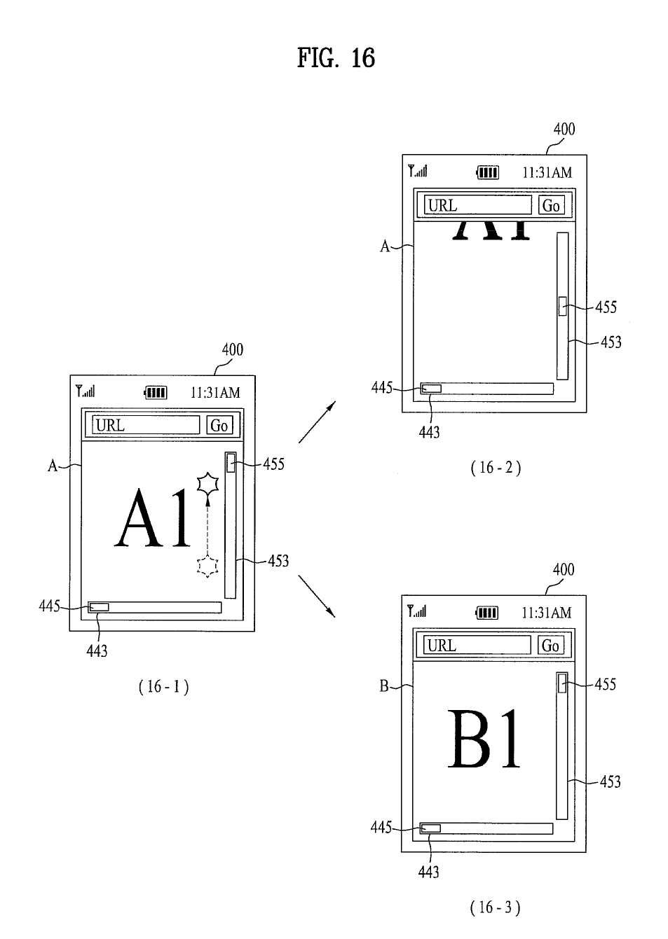

FIG. 14 is a flowchart for a method of controlling a mobile terminal according to an embodiment of the present invention. FIG. 15 and FIG. 16 are diagrams of display screen configurations for implementing a method of controlling a mobile terminal according to an embodiment of the present invention.

Referring to FIG. 15 (15-1) and FIG. 16 (16-1), a first web browser A can be displayed on the touchscreen 400 in a manner of zooming in a first current webpage A1 [S141].

Thereafter, a touch & drag can be inputted to the touchscreen 400 [S142].

If the touch & drag is inputted, the controller 180 determines a speed of the inputted touch & drag [S143].

As a result of the determination [S143], if the speed of the touch & drag is lower than a predetermined speed, referring to FIG. 15 (15-2) and FIG. 16 (16-2), the controller 180 is able to control the first current web browser A1 to be scrolled along a direction of the touch & drag [S144].

On the contrary, as a result of the determination [S143], if the speed of the touch & drag is equal to or higher than the predetermined speed, the controller 180 determines a trace of the touch & drag [S145].

As a result of the determination [S145], if the trace of the touch & drag is a horizontal straight line, referring to FIG. 15 (15-3), the controller 180 is able to recognize the touch & drag of the horizontal straight line trace as the webpage switch command [S146]. For instance, the touch & drag of the horizontal straight line trace in a left direction corresponds to a selection of the icon ‘next’. And, the touch & drag of the horizontal straight line trace in a right direction can correspond to a selection of the icon ‘previous’.

Meanwhile, if the trace of the touch & drag is a vertical straight line, referring to FIG. 16 (16-3), the controller 180 is able to recognize the touch & drag having the vertical straight line trace as the web browser switch command [S147]. For instance, if the touch & drag has the vertical straight line trace in a top direction, the web browser is switched in an execution order of the web browser. For another instance, if the touch & drag has the vertical straight line trace in a bottom direction, the web browser can be switched in order reverse to the execution order of the web browser.

After the first web browser has been executed, a preset homepage is displayed. Thereafter, since the first web browser does not move into another webpage, even if the webpage switch command is inputted, the first web browser may not have a previous or next webpage to go to. In this case, although the speed of the touch & drag inputted to the touchscreen is equal to or higher than the predetermined speed and the trace of the touch & drag is the horizontal straight line, the controller 180 is able to control the inputted touch & drag to be recognized as a scroll command.

According to the above description, if the speed of the touch & drag is lower than the predetermined speed, the touch & drag is recognized as the scroll command. If the speed of the touch & drag is equal to or higher than the predetermined speed, the touch & drag is recognized as the webpage switch command or the web browser switch command, by which the present embodiment is non-limited. For instance, if the speed of the touch & drag is lower than the predetermined speed, the touch & drag is recognized as the webpage switch command or the web browser switch command. If the speed of the touch & drag is equal to or higher than the predetermined speed, the touch & drag can be recognized as the scroll command.

Accordingly, the present invention provides the following effects and/or advantages.

First of all, according to at least one of embodiments of the present invention, a switching to a different webpage from the displayed webpage is facilitated in further consideration of user's convenience despite a user input unit of a limited type and a display screen of a limited size in the mobile terminal.

In particular, a web browser is executed in the mobile terminal and a current webpage can be then displayed on the executed web browser. If a single touch action is performed on the touchscreen provided to the mobile terminal, the current webpage can be switched to a previous webpage or a next webpage. Moreover, if a single touch action is performed, the current web browser disappears and another web browser can appear. Therefore, a user's convenience can be further enhanced.

It will be apparent to those skilled in the art that various modifications and variations can be specified into other form(s) without departing from the spirit or scope of the inventions.

In addition, the above-described methods can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet). And, the computer can include the controller 180 of the terminal.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal comprising:
a touchscreen;
a wireless communication unit for internet access; and
a controller configured to:
simultaneously execute a first web browser and a second web browser;
display the executed first web browser on the touchscreen;
if a first touch action is performed on the touchscreen while the first web browser displays a first current webpage, control the first web browser to display a first previous webpage or a first next webpage; and
if a second touch action is performed on the touchscreen while the first web browser displays the first current webpage, control the first web browser to disappear and control the second web browser to appear.

2. The mobile terminal of claim 1, wherein the controller controls the second web browser not to be displayed when the first web browser is displayed and wherein the controller controls the first web browser not to be displayed when the second web browser is displayed.

3. The mobile terminal of claim 1, wherein the controller controls a third web browser to be further executed and wherein each time the second touch action is performed, the controller controls the first to third web browsers to be sequentially displayed on the touchscreen.

4. The mobile terminal of claim 1, wherein if the first touch action is performed while the first web browser displays the first current webpage, the controller controls a list of the first previous webpage or the first next webpage to be displayed and wherein if a specific one webpage is selected from the list, the controller controls the selected webpage to be displayed on the first web browser.

5. The mobile terminal of claim 4, wherein the controller controls the list to be displayed as a thumbnail in a manner of being overlaid on the first current webpage.

6. The mobile terminal of claim 1, wherein if the first touch action is performed on the touchscreen while the second web browser displays a second current webpage, the controller controls the second web browser to display a second previous webpage or a second next webpage.

7. The mobile terminal of claim 6, wherein if the second touch action is performed on the touchscreen while the second web browser displays the second current webpage, the controller controls the second web browser to disappear and also controls the first web browser to be displayed.

8. The mobile terminal of claim 1, wherein the controller displays a first icon and a second icon for receiving an input of the first touch action, wherein if the first icon is touched with a pointer as the first touch action, the controller controls the first web browser to go to the first previous webpage from the first current webpage, and wherein if the second icon is touched with the pointer as the first touch action, the controller controls the first web browser to go to the first next webpage from the first current webpage.

9. The mobile terminal of claim 8, wherein if at least one of the first icon and the second icon is touched with the pointer and the pointer is then dragged in a specific direction, the controller controls the second touch action to be inputted.

10. The mobile terminal of claim 1, wherein the controller controls a first touch & drag performed along a first trace to be recognized as the first touch action and wherein the controller controls a second touch & drag performed along a second trace to be recognized as the second touch action.

11. The mobile terminal of claim 10, wherein if the first or second touch & drag is inputted while the first current webpage is displayed on the first web browser by being fully zoomed out, the controller controls the inputted first or second touch & drag to be recognized as the first or second touch action and wherein if the first or second touch & drag is inputted while the first current webpage is displayed on the first web browser by being zoomed in, the controller controls the inputted first or second touch & drag to be recognized as a scroll command for scrolling the first current webpage in a corresponding trace direction.

12. The mobile terminal of claim 10, wherein the first trace is a straight line trace in a left or right direction and wherein the second trace is a trace different from a straight line.

13. A method of controlling a mobile terminal, comprising:
simultaneously executing a first web browser and a second web browser;
displaying the executed first web browser on the touchscreen;
if a first touch action is performed on the touchscreen while the first web browser displays a first current webpage, controlling the first web browser to display a first previous webpage or a first next webpage; and
if a second touch action is performed on the touchscreen while the first web browser displays the first current webpage, controlling the first web browser to disappear and controlling the second web browser to appear.

14. The method of claim 13, wherein the second web browser is not displayed when the first web browser is displayed and wherein the first web browser is not displayed when the second web browser is displayed.

15. The method of claim 13, further comprising further executing a third web browser, wherein each time the second touch action is performed, the first to third web browsers are sequentially displayed on the touchscreen.

16. The method of claim 13, wherein displaying the first previous webpage or the first next webpage comprises:
if the first touch action is performed while the first web browser displays the first current webpage, displaying a list of the first previous webpage or the first next webpage; and
if a prescribed one webpage is selected from the list, displaying the selected webpage on the first web browser.

17. The method of claim 16, wherein the list is displayed as a thumbnail in a manner of being overlaid on the first current webpage.
